(19) United States
(12) Patent Application Publication
(10) Pub. No.: US 2010/0089254 A1
(43) Pub. Date: Apr. 15, 2010

(54) FOOD SLICER AND ASSOCIATED FOOD PRODUCT PUSHER

(76) Inventors: Anatoly Gosis, Palatine, IL (US); Yury Shkolnikov, Glenview, IL (US); James C. Fournier, Gurnee, IL (US); Frank A. Bondarowicz, Park Ridge, IL (US)

Correspondence Address: THOMPSON HINE LLP;Intellectual Property Group, P.O Box 8801, DAYTON, OH, 45401-8801, US

(21) Appl. No.: 12/250,945

(22) Filed: Oct. 14, 2008

(51) Int. Cl. A47J 43/04; B23D 19/00

(52) U.S. Cl. 99/537; 83/474

(57) ABSTRACT

A food slicer includes a support member having a base portion and an upstanding portion. A rotatable cutting blade is secured to the upstanding portion for slicing food product. A food product table is mounted for movement past the cutting blade for holding product while being sliced by the cutting blade. An adjustable gage plate enables slice thickness adjustment. A pusher assembly is configured to provided gravity induced movement of the pusher assembly along the slide rod toward the gage plate.

### TECHNICAL FIELD

This application relates generally to food slicers and, more particularly, to a food pusher for a food slicer.

### BACKGROUND

The basic design of both manual and automatic food slicers has proven to be quite effective and durable throughout the years. Food slicers are utilized to slice a number of food products such as meats, cheeses and the like in a variety of environments such as delicatessens, supermarkets, and restaurants to name a few. Food slicers generally handle a variety of products of different shapes, sizes, and textures and provide slices of different thicknesses.

Gravity food slicers with reciprocating food product tables typically have a feature called a “pusher” that engages the food product on its top surface or end opposite the slicing blade to assist in holding the food product and increase its stability during slicing and movement of the food product table, as well as to urge the food product toward the slicer knife.

It would be desirable to provide a slicer with a pusher that includes features that facilitate product pushing and/or pusher cleanability.

### SUMMARY

In one aspect, a food slicer includes a support member having a base portion and an upstanding portion. A rotatable cutting blade is secured to the upstanding portion for slicing food product. A food product table is mounted for movement past the cutting blade for holding product while being sliced by the cutting blade. The food product table includes a slide rod. An adjustable gage plate is provided for varying thickness of slices cut by said cutting blade. A pusher assembly is mounted for movement along the slide rod for pushing food product on the food product table toward the gage plate under force of gravity. The pusher assembly includes a weight member and a pusher arm, with the weight member disposed about the slide rod and the pusher arm extending from the weight member. A mass of the weight member is at least 50% of a total mass of the pusher assembly to provide an effective gravity induced movement of the pusher assembly along the slide rod.

In certain implementations the pusher arm may be removably attached to the weight member and/of rotational movement of the pusher assembly about the slide rod axis may be restricted to ten degrees or less and/or a pusher arm support bracket may be located at the outer side of the food product table.

In another aspect, a food slicer includes a support member having a base portion and an upstanding portion. A rotatable cutting blade is secured to the upstanding portion for slicing food product. A food product table is mounted for movement past the cutting blade for holding product while being sliced by the cutting blade, the food product table including a slide rod. An adjustable gage plate is provided for varying thickness of slices cut by said cutting blade. A pusher assembly is mounted for movement along the slide rod for pushing food product on the food product table toward the gage plate under force of gravity. The pusher assembly has a slide rod axis to pusher arm end dimension of at least eight inches, and the pusher assembly configured such that at least 60% of a total mass of the pusher assembly is located within two inches of the slide rod axis.

### BRIEF DESCRIPTION OF THE DRAWINGS

FIG. 1 is a perspective view of a food slicer;

FIG. 2 is a front elevation of the food slicer of FIG. 1;

FIG. 3 is a perspective of a food product table;

FIG. 4 is another perspective of the food product table of FIG. 3;

FIG. 5 is a perspective view of a pusher arm;

FIG. 6 is perspective view of the table of FIG. 3 with pusher arm removed; and

FIG. 7 is partial perspective end view of the table of FIG. 3 with pusher arm supported on an arm bracket.

### DETAILED DESCRIPTION

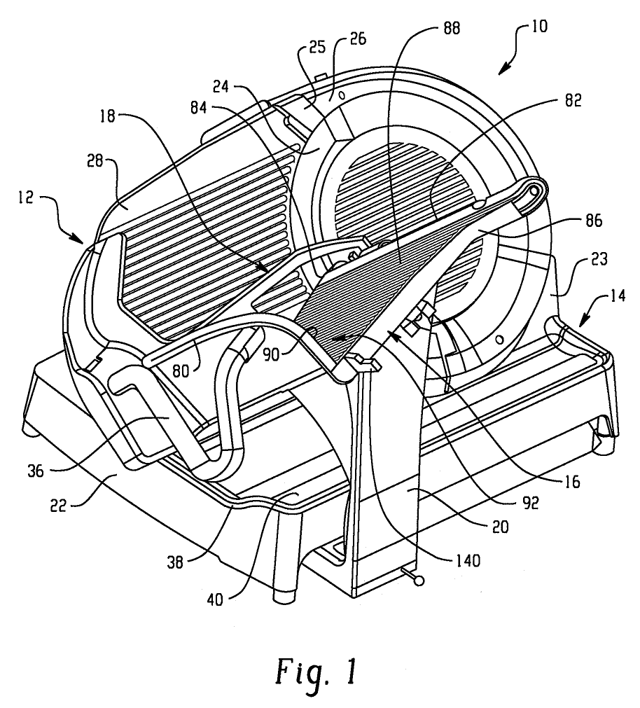

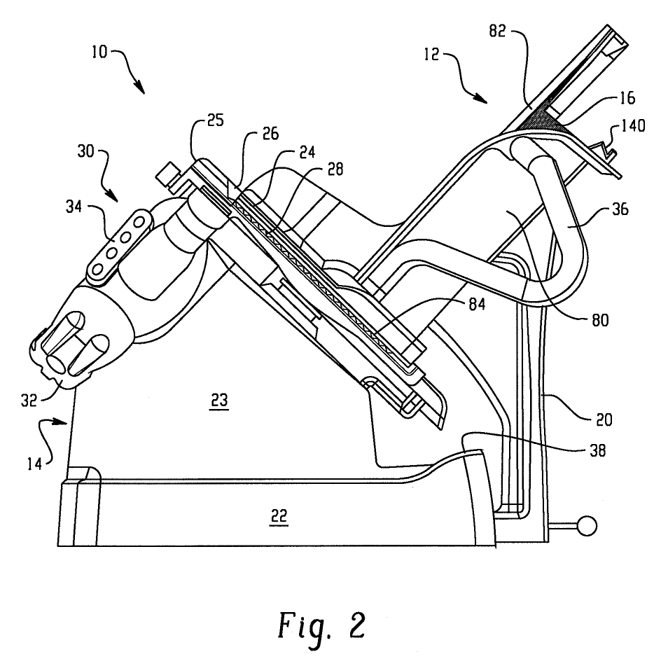

A food slicer is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms.

FIGS. 1 and 2 illustrate the basic components of the food slicer 10, including a food handling portion generally illustrated by reference numeral 12 and a support portion, housing or member generally illustrated by reference numeral 14.

The food handling portion 12 includes a product table 16, a push assembly 18 and a product table support arm 20. The support portion 14 includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

The product table includes a front side 80, a rear side 82, an inner or gage plate side 84 positioned proximate the gage plate 28 and an outer side 86 spaced away from the gage plate. The product table includes an upper food support surface 88 with an upwardly extending support wall 90 toward the front thereof.

Briefly, for manual slicing, a food product (not illustrated) is placed on the product table 16, typically in a food product location 92 adjacent the wall 90, with the food product end to be cut or sliced resting upon the gage plate 28 with the product table 16 in its forward position. The operator adjusts the gage plate adjustment mechanism 32 which moves the gage plate 28 with respect to the blade 24 to provide a slice thickness gap therebetween that corresponds to the desired thickness for slicing of the product. The control buttons 34 are then accessed to turn the motor on which in turn rotates the blade 24. The pusher assembly 18 is typically placed at the exposed end of the food product to urge the food product toward the gage plate and cutting blade.

The operator then pushes the product table 16 preferably via a handle 36 or other contact point toward the blade whereby the blade 24 slices the product to the desired thickness. The operator then pulls the product table 16 away from the blade for continued slicing of the product as described above. Automated reciprocal movement of the food product table may also be provided.

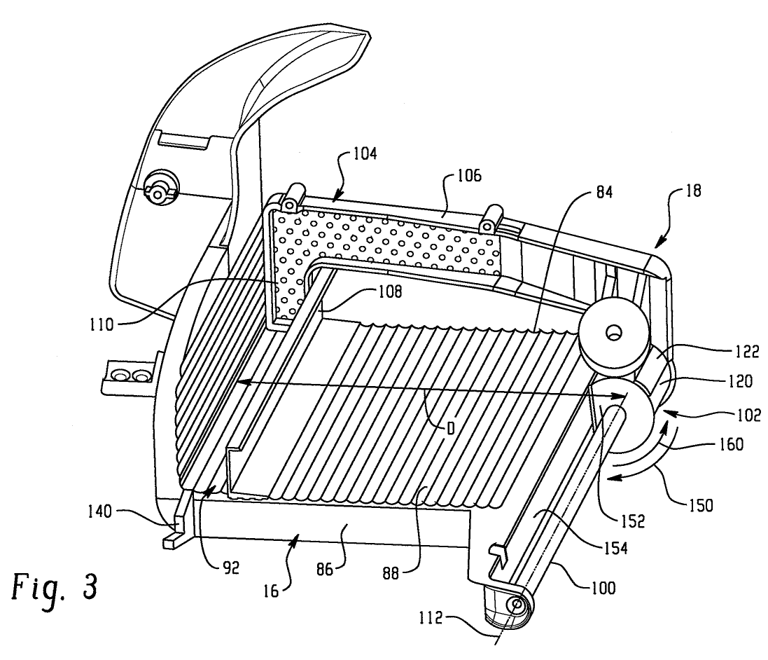

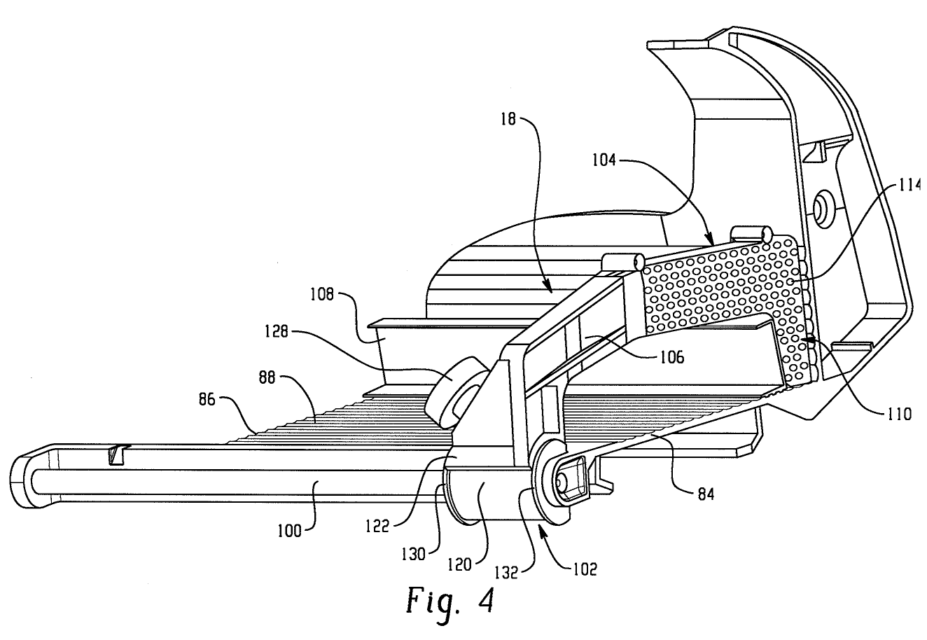

Referring to FIGS. 3 and 4, perspective views of a food product table 16 and pusher assembly 18 are shown. The food product table includes a slide rod 100 at the rear side 82 and the pusher assembly 18 is mounted for movement along the slide rod. The pusher assembly includes a weight member 102 and a pusher arm 104. The weight member 102 is disposed about the slide rod 100 and typically includes one or more internal bearings to facilitate sliding along the slide rod. The arm 104 extends from the weight member toward the food product receiving location 92 of the table, and includes an elevated portion 106, for providing clearance for a product fence 108, and a downwardly extending portion 110 that rests against the surface 88 of the table.

When installed on the food slicer the gage plate side 84 of the table is located lower than the outer side 86 of the table, placing the food support surface 88 and the slide rod 100 in a downwardly inclined orientation that tends to cause the pusher assembly to move toward the gage plate under the force of gravity. To increase the effectiveness of the gravity feed of the pusher assembly, a significant portion of the overall mass of the pusher assembly is incorporated into the weight member 102, which is in close proximity to the axis 112 of the slide rod 100. In one embodiment, the mass of the weight member is at least 50% of the total mass of the pusher assembly 18. Increased effectiveness of the gravity feed can be obtained by increasing the percent mass of the weight member.

For example, the mass of the weight member may be at least 60% of the total mass of the pusher assembly 18, at least 70% of the total mass of the pusher assembly or at least 80% of the total mass of the pusher assembly. Beneficially, because the illustrated weight member is disposed about the slide rod 100 the mass of the weight member provides an effective coaxial bearing loading. Variations of the weight member configuration are possible. Such variations may desirably be configured such that at least 60%, or in some cases at least 70%, of a total mass of the pusher assembly is located within two inches, or in some cases within one inch, of the slide rod axis. In cases where a slide rod axis to pusher arm end dimension D is at least eight inches, such implementation will again places much of the pusher assembly mass in close proximity to the slide rod axis.

In one example, the weight member is formed of a relatively heavy material, such as steel, and the pusher arm is formed of a lighter, but still rigid material, such as plastic. However, variations in material are possible.

The end portion of the pusher arm 104 may typically include projections 114 for engaging the end face of the food product on the table. Such projections may be formed unitary with the arm or separate from the arm and then attached to the arm.

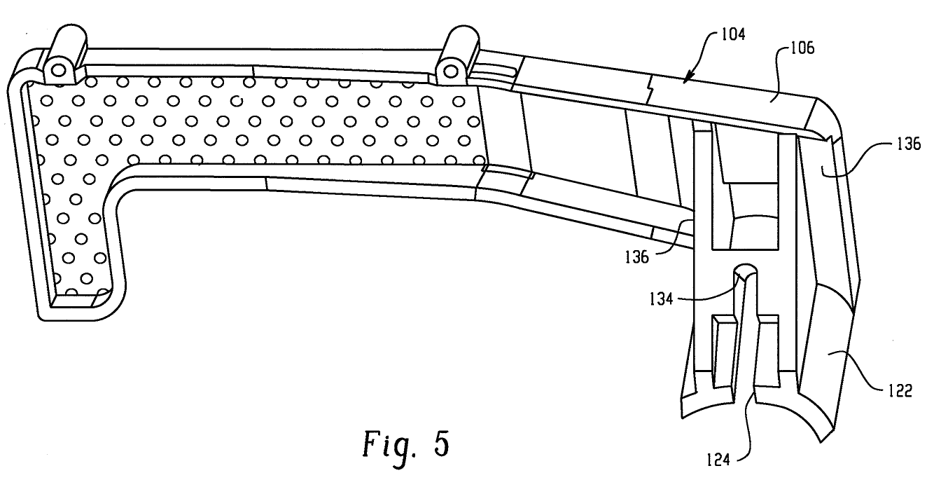

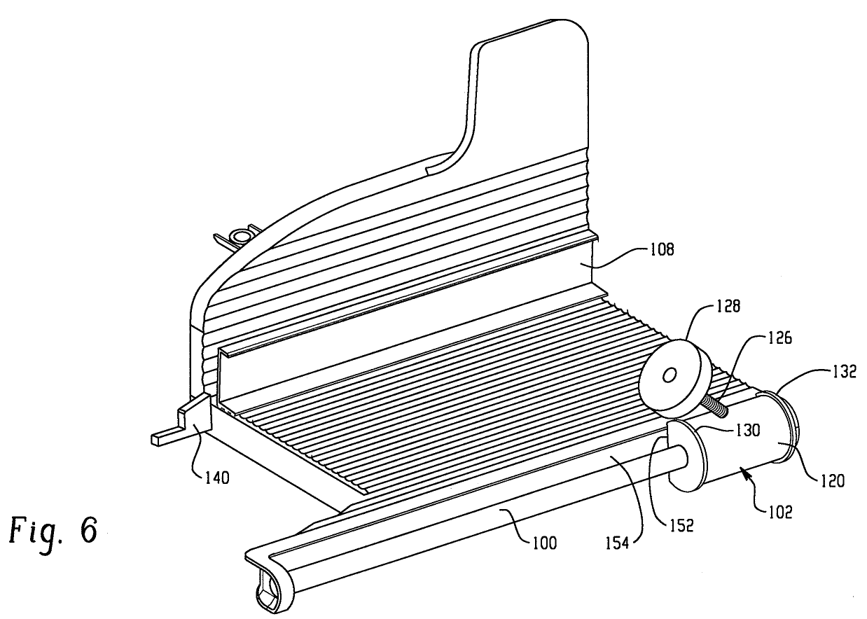

In the illustrated embodiment, the pusher arm 104 is removably mounted to the weight member 102. Specifically, the weight member includes a cylindrical outer surface portion 120. An attachment end of the pusher arm 104 includes at least one cylindrical surface portion 122 matingly seated against the cylindrical outer surface portion 120 of the weight member. As shown in FIG. 5, the cylindrical surface portion 122 of the attachment end of the pusher arm includes a slot 124. As shown in FIG. 6, an attachment rod 126 extends from the cylindrical outer surface portion 120 of the weight member. When the pusher arm 104 is attached to the weight member 102, the rod 126 extends angularly upward through the slot 124. At least a portion of the attachment rod 124 is threaded, and a handle member 128 is threadingly disposed on the attachment rod. The handle is movable (e.g., by rotation) between an assembled position that presses the attachment end of the pusher arm 104 against the weight member 102, and a release position that enables the pusher arm 104 to be removed from the weight member 102. Such removal facilitates cleaning of the arm 104. While the illustrated attachment rod 126 is shown threaded in its entirety, some lengthwise portion of the rod could be unthreaded. Moreover, while the use of a rotating handle is contemplated in connection with the attachment rod, other mechanisms could be provided for moving the handle between the assembled and release positions.

As best seen in FIGS. 4 and 6, the weight member 102 includes spaced apart lip portions 130 and 132 that interact with the attachment end of the pusher arm 104 to inhibit sliding movement of the pusher arm relative to the weight member in a lengthwise direction along weight member. When the handle member 128 is in the assembled position, it presses the attachment and of the pusher arm against the surface 120 such that end portions of the cylindrical portion 122 of the pusher arm are engaged with, or in close proximity to the lips 130 and 132. As best seen in FIG. 5, the attachment end of the pusher arm 104 includes a raised portion 134 that partially surrounds the attachment rod in the assembled state. Ribs 136 provide a stable, rigid connection between elevated arm portion 106 and cylindrical portion 122.

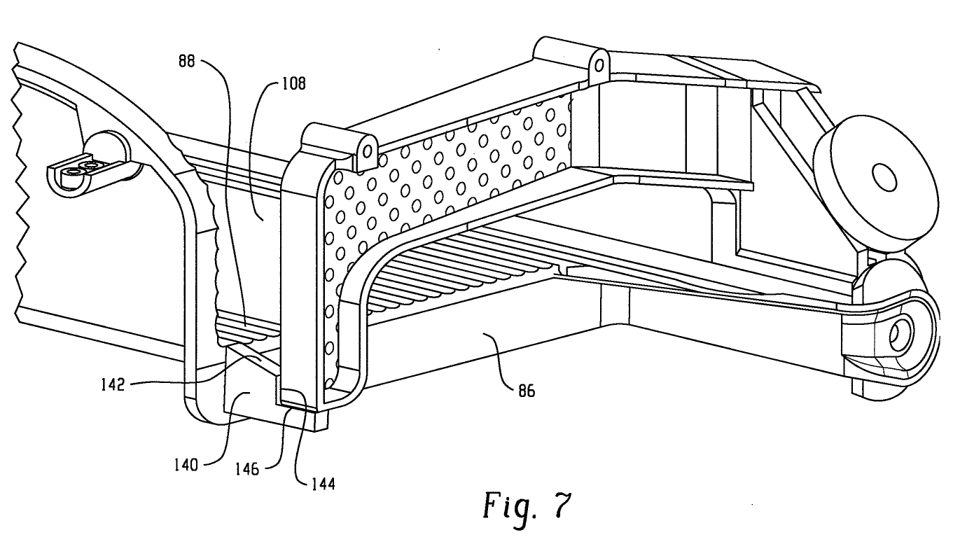

Referring to FIGS. 3 and 7, a pusher arm bracket 140 is located at the outer side 86 of the food product table for holding the pusher arm 104 in a position away from the outer side of the food product table. The pusher arm bracket includes a ramp portion 142 extending downward and away from the upper surface 88 of the food product table to a step portion 144. The step portion 144 extends down to a support ledge 146 for the pusher arm. When the operator desires to move the pusher arm back up onto the table, the operator raises the pusher arm up to the ramp surface 142 and then moves the pusher arm toward the product table so that the pusher arm slides easily up and onto the food support surface 88.

As best seen in FIGS. 3 and 6, the weight member 102 is configured to interact with a portion of the food product table 16 such that, when the food engaging end 110 of the pusher arm rests on the food support surface 88, rotation of the pusher assembly about the axis 112 of the slide rod in a direction 150 (generally clockwise in FIG. 3) to lift the food engaging end 110 of the pusher arm off the food support surface is limited. In one example, such rotation is limited to no more than about 5 degrees, or to no more than about 3 degrees, with a 1 degree of rotation limit in direction 150 being contemplated. In this manner, upward shifting of the food product due to forces exerted during slicing can be inhibited. The weight member 102 includes a planar surface portion 152 that lies in close proximity to a planar surface portion 154 of the table. Upon rotation of the weight member the surface portions contact each other, preventing further rotation.

In order to enable the pusher arm to be seated on the bracket 140, a greater degree of rotation may be provided in a direction 160, which is opposite direction 150 of FIG. 3. Specifically, the pusher assembly may be rotated, by way of example, by about 5 degrees of rotation. However, implementations in which the total rotation of the pusher assembly about the axis of the slide rod is limited to no more than about 10 degrees, or no more than about 6 degrees, are primarily contemplated, with two or less degrees of rotation in direction 150 (when the food engaging end of the pusher arm rests on surface 88).

It is to be clearly understood that the above description is intended by way of illustration and example only, is not intended to be taken by way of limitation, and that various changes and modifications are possible.

What is claimed is:

1. A food slicer, comprising:
a support member having a base portion and an upstanding portion;
a rotatable cutting blade secured to the upstanding portion for slicing food product;
a food product table mounted for movement past the cutting blade for holding product while being sliced by the cutting blade, the food product table including a slide rod;
an adjustable gage plate for varying thickness of slices cut by said cutting blade; and
a pusher assembly mounted for movement along the slide rod for pushing food product on the food product table toward the gage plate under force of gravity, the pusher assembly including a weight member and a pusher arm, the weight member disposed about the slide rod, the pusher arm extending from the weight member, wherein a mass of the weight member is at least 50% of a total mass of the pusher assembly.

2. The food slicer of claim 1 wherein the mass of the weight member is at least 60% of the total mass of the pusher assembly.

3. The food slicer of claim 2 wherein the mass of the weight member is at least 70% of the total mass of the pusher assembly.

4. The food slicer of claim 3 wherein the pusher arm is removably mounted to the weight member.

5. The food slicer of claim 4 wherein the weight member is configured to interact with the food product table such that, when a food engaging end of the pusher arm rests on a food support surface of the food product table, rotation of the pusher assembly about an axis of the slide rod in a direction to lift the food engaging end of the pusher arm off the food support surface is limited to no more than about 5 degrees.

6. The food slicer of claim 5 wherein the weight member is configured to interact with the food product table such that, when the food engaging end of the pusher arm rests on the food support surface of the food product table, rotation of the pusher assembly about the axis of the slide rod in the direction to lift the food engaging end of the pusher arm off the food support surface is limited to no more than about 3 degrees.

7. The food slicer of claim 6 wherein the weight member is configured to interact with the food product table such that total rotation of the pusher assembly about the axis of the slide rod is limited to no more than about 10 degrees.

8. The food slicer of claim 7 wherein the weight member is configured to interact with the food product table such that total rotation of the pusher assembly about the axis of the slide rod is limited to no more than about 6 degrees

9. The food slicer of claim 7 wherein the food product table includes a front side, a rear side opposite the front side, a gage plate side and an outer side opposite the gage plate side, a pusher arm bracket is located at the outer side of the food product table for holding the pusher arm in a position away from the outer side of the food product table.

10. The food slicer of claim 9 wherein the pusher arm bracket includes a ramp portion extending downward from the food support surface of the food product table to a step portion, the step portion extending to a support ledge for the pusher arm.

11. The food slicer of claim 10 wherein the weight member includes a cylindrical outer surface portion and an attachment end of the pusher arm includes at least one cylindrical surface portion matingly seated against the cylindrical outer surface portion of the weight member.

12. The food slicer of claim 11 wherein the cylindrical surface portion of the attachment end of the pusher arm includes a slot, an attachment rod extends from the cylindrical outer surface portion of the weight member and upward through the slot.

13. The food slicer of claim 12 wherein the weight member includes spaced apart lip portions that interact with the attachment end of the pusher arm to inhibit sliding movement of the pusher arm relative to the weight member in a lengthwise direction along weight member.

14. The food slicer of claim 12, wherein the attachment end of the pusher arm includes a portion partially surrounding the attachment rod, at least a portion of the attachment rod is threaded, and a handle member is threadingly disposed on the attachment rod, the handle movable between an assembled position that presses the attachment end of the pusher arm against the weight member, and a release position that enables the pusher arm to be removed from the weight member.

15. The food slicer of claim 3 wherein the mass of the weight member is at least 80% of the total mass of the pusher assembly.

16. The food slicer of claim 1 wherein the weight member includes at least one internal bearing.

17. A food slicer, comprising:
a support member having a base portion and an upstanding portion;
a rotatable cutting blade secured to the upstanding portion for slicing food product;
a food product table mounted for movement past the cutting blade for holding product while being sliced by the cutting blade, the food product table including a slide rod;
an adjustable gage plate for varying thickness of slices cut by said cutting blade; and
a pusher assembly mounted for movement along the slide rod for pushing food product on the food product table toward the gage plate under force of gravity, the pusher assembly having a slide rod axis to pusher arm end dimension of at least eight inches, the pusher assembly configured such that at least 60% of a total mass of the pusher assembly is located within two inches of the slide rod axis.

18. The food slicer of claim 15 wherein the pusher assembly includes a weight member and a pusher arm, the weight member disposed about the slide rod, the arm extending from the weight member and removably attached to the weight member, wherein a mass of the weight member is at least 60% of the total mass of the pusher assembly.

19. The food slicer of claim 18 wherein the pusher assembly interacts with the food product table such that total rotation of the pusher assembly about an axis of the slide rod is limited to no more than about 10 degrees.

20. The food slicer of claim 19 wherein the food product table includes a front side, a rear side opposite the front side, a gage plate side and an outer side opposite the gage plate side, a pusher arm bracket is located at the outer side of the food product table for holding the pusher arm in a position away from the outer side of the food product table, the pusher arm bracket includes a ramp portion extending downward from an upper surface of the food product table to a step portion, the step portion extending to a support ledge for the pusher arm.
